(19) United States
(12) Patent Application Publication
(10) Pub. No.: US 2004/0260620 A1
(43) Pub. Date: Dec. 23, 2004

(54) Storepath for sharing commerce assets

(75) Inventors: Robert M. H. Dunn, Toronto (CA); Victor S. Chan, Thornhill (CA); Brenda M. Lam, North York (CA); Wan Ngai W. Lee, North York (CA); Lev Mirlas, Thornhill (CA); Paul K. H. Yu, Toronto (CA)

Correspondence Address: Diana L. Roberts, International Business Machines, Intellectual Property Law, 11400 Burnet Road, Austin, TX, 78758, US

(73) Assignees: INTERNATIONAL BUSINESS MACHINES CORPORATION, ARMONK, NY; IBM Corporation

(21) Appl. No.: 10/666,799

(22) Filed: Sep. 18, 2003

(30) Foreign Application Priority Data
Jun. 17, 2003 (CA) 2,432,665

(51) Int. Cl. G06F 17/60

(52) U.S. Cl. 705/26

(57) ABSTRACT

A method of accessing information relating to various commerce assets such as products or services offered at virtual stores participating in a virtual marketplace is disclosed. The commerce assets in each store are related by storepath relationships correlating asset types among related stores. The method uses the storepath relationships to retrieve information about commerce asset types available from a store.

### FIELD OF THE INVENTION

The present invention relates to data processing, and more particularly to a method of accessing information in an e-commerce system.

### BACKGROUND OF THE INVENTION

The Internet provides an optimum vehicle for facilitating the exchange of the latest product information between suppliers, sellers and buyers. An increasing volume of business-to-business (B2B) and business-to-consumer (B2C) transactions is now conducted on the e-commerce platform, replacing the traditional brick-and-mortar systems. For example, in 1999 alone, the Intel™ Corporation reportedly sold almost half of its $30 billion in annual computer chip sales directly through its web site, and it is planning to move nearly all of its sales to the web in the near future.

E-commerce related transactions are typically based on a client/server paradigm 100 as shown FIG. 1. As understood in the art, the client/server is an architecture in which a client machine 102 (such as a workstation, personal computer, personal digital assistant, cellular phone, etc.) is the requesting machine and an application server 104 is the supplying machine, both of which are interconnected by way of a network 108. The application server 104 is a server computer and one or more programs that provide the logic for an online or automated application, and is typically part of a larger, distributed computing system. Application servers 104 are often modeled as a component of a three-tier system which includes a graphical user interface (GUI) server, an application or business logic server, and a resource manager 110 for accessing data stored in databases 106. One such application server 104 is the WebSphere™ product from International Business Machines (IBM). WebSphere™ is available for a number of platforms, including computers from personal computers to high-end main frames running operating systems ranging from Microsoft Windows NT™, to IBM's AIX™, to the open source Linux.

In a typical e-commerce transaction, the client 102 requesting a store operation such as product catalog information interacts with the application server 104 that contains the business logic for synchronizing and managing access to the requested information located at one or more of the databases 106. The clients 102 communicate with the application server 104 through network 108. The network 108 may be an intranet, or the Internet, depending upon the intended geographical reach of the system. The interface (not shown) between the application server 104 and the resource manager 108 may also be an intranet, the Internet, or any other type of proprietary network.

A resource manager 110 stores and retrieves information relating to the store operation on the databases 106 and forwards the requested data from the databases 106 to the application server 104 for further processing, and eventually to the clients 102. The databases 106 are generally co-located with the resource manager 110, and serve as archives of store operation information such as catalogs, product specifications, price list, product availability and similar types of data typically requisitioned by one of the clients 102.

In an attempt to improve their virtual store, resellers are continuously looking for ways to update the information regarding the products or services offered at their website in a manner that is transparent to their buyers. However, resellers are often faced with the difficult task of supporting and updating a large number of constantly changing catalogs in order to interact and exchange accurate product information to their potential buyers. In the case of resellers offering products or services from manufacturers, the problem of updating becomes particularly prevalent. For instance, the Business Depot™ chain offers a plethora of home renovation products made by a variety of manufacturers. For products such as tiles that are continually changed or redesigned, it becomes a arduous task for the Business Depot™ to keep track of the constantly changing inventories of tiles manufacturers.

Furthermore, certain manufacturers may have enormous catalogs and their systems may include complex configuration tools, making it impossible for a potential purchaser to access the catalogs without the requisite proprietary tools. Acquisition of such tools for the purchase is often not feasible for a shopper.

The problem of large catalogs is further exacerbated by the fact that the manufacturers catalogs are revised and modified on a regular basis, making it difficult for a reseller to constantly download and update huge volumes of inventory databases of every other manufacturer or reseller to maintain current and accurate data for same.

A number of solutions have been proposed to address the problem of dynamically updating the contents of virtual stores in the past. One solution has been to regroup the related stores in clusters to make updating of shared data among the stores less taxing. However, this solution suffers from a number of drawbacks. A store seldom belongs to a single group. Moreover, there is no distinction made among the store groups as to what resources or assets are supported by the group, and there is no hierarchy of the various store groups. Also, different tools are required to manage resources defined in a store as opposed to those in a store group.

Another solution seeks to define relationships for commerce assets for each store. However, this solution is very laborious and difficult to implement and maintain when dealing with large volumes of store data.

In spite of the past solutions, the problem of dynamic store content still remains a challenge, since the existing solutions are static, based on proprietary technology, and do not provide dynamic control and harmonization of the contents of a plurality of virtual stores.

There is therefore a need for a new dynamic model which allows instantaneous access to constantly changing information about various commerce assets offered on an online store.

### BRIEF SUMMARY OF THE INVENTION

The present invention provides a method and system for sharing of selected commerce assets in a controlled fashion among a number of virtual stores in a marketplace.

In a first aspect, the present invention provides a method of accessing data regarding commerce assets such as products or services offered at virtual stores participating in a virtual marketplace in a client/server system based on a user query for data relating to a commerce asset for a particular asset type at a particular virtual store, the user accessing the client/server system through a client having a graphical user interface to obtain the user query and to display a response to the query, the assets data being stored in a database accessed by a resource manager, an application server interfacing the resource manager with graphical user interface, where the method includes the steps of: (a) establishing a storepath relationship correlating asset types among related stores; (b) resolving the user query into at least a database query executable by the resource manager; (c) retrieving assets data for asset type available at particular virtual store; and (d) returning assets data to user as the response to the query.

In another aspect, the present invention provides a client/server system having at least one client having a graphical user interface for receiving a user's query for data relating to a commerce asset offered at a virtual store stored on a database, and an application server operatively connected to the client graphical user interface, such that the application server includes a business logic component for resolving the query into at least a database query. The client/server system further includes a resource manager operatively connected to the application server, the resource manager including a database management system for processing the database queries, accessing the database containing a response to the query, retrieving and forwarding the response to the application server.

In another aspect, the present invention provides a computer program product having a computer readable medium tangibly embodying computer executable code for directing a data processing system to access data regarding assets such as products or services offered at virtual stores participating in a marketplace in a client/server system based on a user query about data asset for a particular asset type at a particular virtual store, the user accessing the client/server system through a client having a graphical user interface to obtain the user query and to display a response to the query, the assets data being stored in a database accessed by a resource manager, an application server interfacing the resource manager with graphical user interface, said computer program product comprising: (a) code for establishing a storepath relationship correlating asset types among related stores; (b) code for resolving the user query into at least a database query executable by the resource manager; (c) code for retrieving assets data for the asset type available at a particular virtual store; and (d) code for returning assets data to user as the response to the user query.

In yet another aspect, the present invention provides a computer data signal embodied in a carrier wave and having means in the computer data signal for directing a data processing system to access data regarding assets such as products or services offered at virtual stores participating in a virtual marketplace in a client/server system based on a user query about data asset for a particular asset type at a particular virtual store, the user accessing the client/server system through a client having a graphical user interface to obtain the user query and to display a response to the query, the assets data being stored in a database accessed by a resource manager, an application server interfacing the resource manager with graphical user interface, the computer data signal comprising: (a) means in the computer data signal for establishing a storepath relationship correlating asset types among related stores; (b) means in the computer data signal for resolving the user query into at least a database query executable by the resource manager; (c) means in the computer data signal for retrieving assets data for the asset type available at a particular virtual store; and (d) means in the computer data signal for returning the assets data to user as the response to the user query.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

A better understanding of these and other embodiments of the present invention can be obtained with reference to the following drawings which show by way of example embodiments of the present invention, in which:

FIG. 1 is a schematic diagram of an exemplary client/server paradigm;

FIG. 2 is a schematic diagram of a web-based client/server system according to an embodiment of the present invention;

FIG. 3 is a diagrammatic representation of commerce asset types for a store hosted in the client/server system of FIG. 2;

FIG. 4 is a diagrammatic representation which shows the relationship between asset types in a store;

FIG. 5 is a diagrammatic representation that illustrates the storepath relationships between stores;

FIG. 6 is a diagrammatic representation which shows the storepath relationships between a store and the relating stores; and

FIG. 7 is a flow diagram that illustrates the operating steps performed by the client/server system of FIG. 2 to process a consumer's query.

### DETAILED DESCRIPTION OF EMBODIMENTS

The present invention is now described with reference to accompanying drawings, wherein like elements are designated by like reference numerals throughout the drawings.

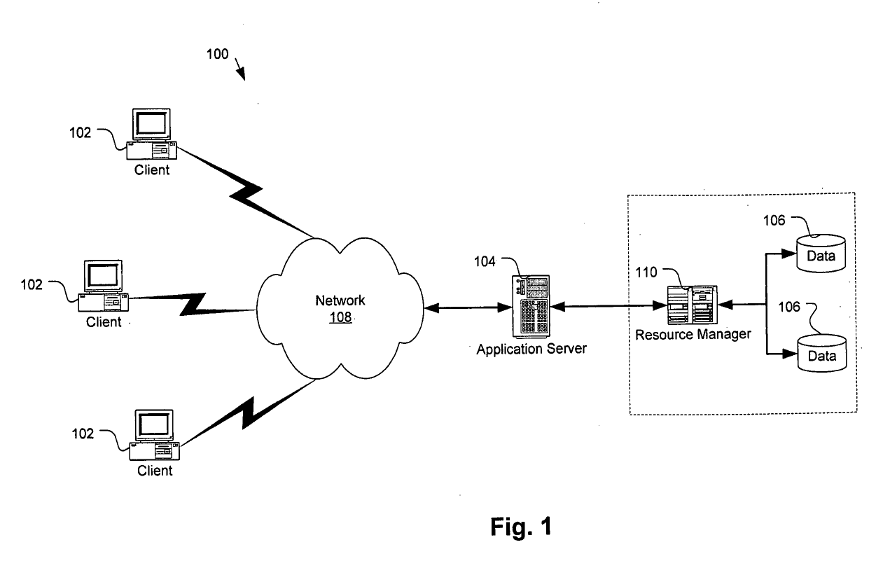

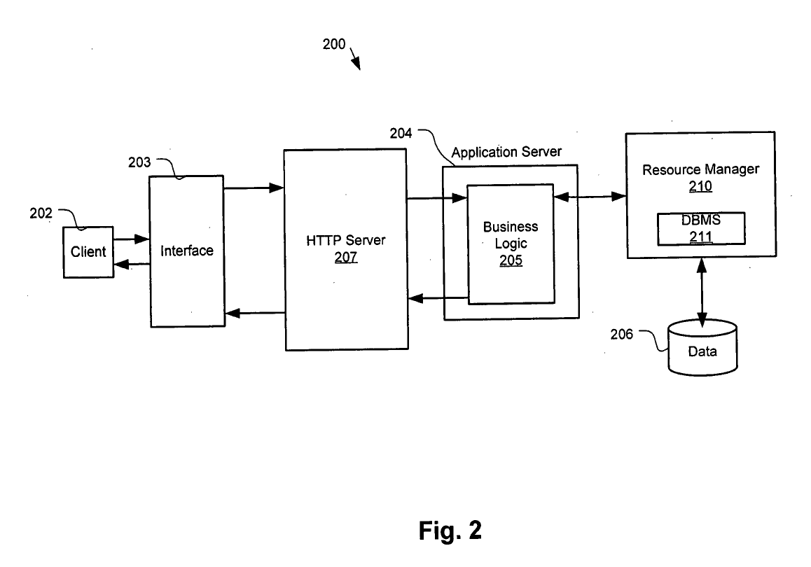

Reference is made to FIG. 2 which shows a runtime topology for a client/server system 200 in a web-based environment. The client/server system 200 is generally based on the model 100 of FIG. 1. In the web-based client/server system 200 of FIG. 2, access to the contents of a hosted store stored in databases 206 can be made via ubiquitous Internet protocols. The client/server system 200 includes a client 202 having a memory and a Graphical User Interface (GUI) 203 allowing a consumer at the client 202 to interface with an application server 204 to access and browse the contents of the online hosted stores.

The contents of the hosted stores are displayed by the GUI interface 203. The GUI interface 203 comprises a browser system that provides a way to look at, read and hear information on the virtual stores in the web environment. A browser interprets hypertext links and allows the user to view sites and navigate from one Internet node to another. A brief overview of web browsers and their interactions within the web environment is set forth in U.S. Pat. No. 5,774,670. As apparent to one skilled in the art, “browsing” refers to a process that can describe moving between web page files associated with the virtual stores of the present invention. “Browsing” can also refer to browsing the Internet, which is also described in U.S. Pat. No. 5,774,670.

The consumer of the network enters a Universal Resource Locator (URL) into the GUI interface 203 requesting certain store information maintained at that specific URL, and the application server 204 navigates the consumer to the store. A consumer can browse the store pages to find information about the desired product or service. The URL is the address of the store accessible on the Internet and contains the name of the protocol required to access the store, a domain name (typically the reseller or manufacturer's domain name) that identifies a specific resources manager 210 on the Internet and a hierarchical description of a file location on the computer. The type of store information at the specific URL depends on the Internet application protocol and could be an HyperText Markup Language (HTML) page, an image file, a program such as a CGI application or Java™ applet. Additional descriptions of URLs can be found in U.S. Pat. No. 5,774,670 and the appendices to U.S. Pat. No. 5,715,314.

Once the consumer's request formulated in the URL is entered into the GUI interface 203, the GUI interface 203 resolves it into a HyperText Transfer Protocol (HTTP) request and sends this request to an HTTP server 207. The HTTP server 207 communicates the consumer's request to the application server 204. At this point, a business logic module 205 of the application server 204 invokes the appropriate procedure to retrieve the requested store information from the database 206 by way of the resource manager 210. The response to the consumer's request is then passed on from the resource manager 210 to the application server 204, and from the application server 204 back to the HTTP server 207, which reformats the response and sends it to the GUI interface 203 for display.

The client/server system 200 allows the GUI interface 203 and the HTTP server 207 functions to be separated from the business logic 205 of the application server 204. The business logic 205 can be implemented in servlets or Java Server Page (JSP), or by other methods known to those skilled in the art, thereby alleviating the need to resort to custom made proprietary applications to retrieve store asset information.

One aspect of the present invention is the manner by which the stores are defined and the contents thereof stored in the database 206. All stores are based on a generic infrastructure to allow the seller to decide whether a commerce asset offered by the store is to be shared among other stores, and to dynamically change the commerce asset in all stores where the commerce asset is available if a change in the commerce asset occurs.

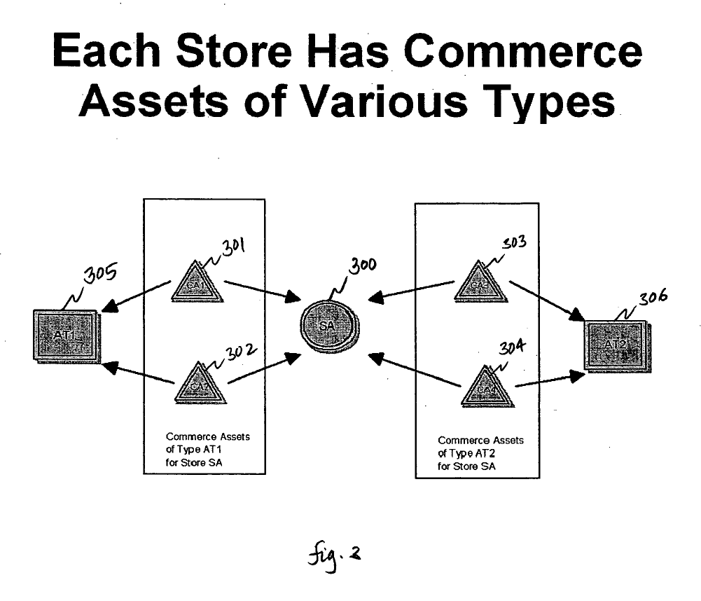

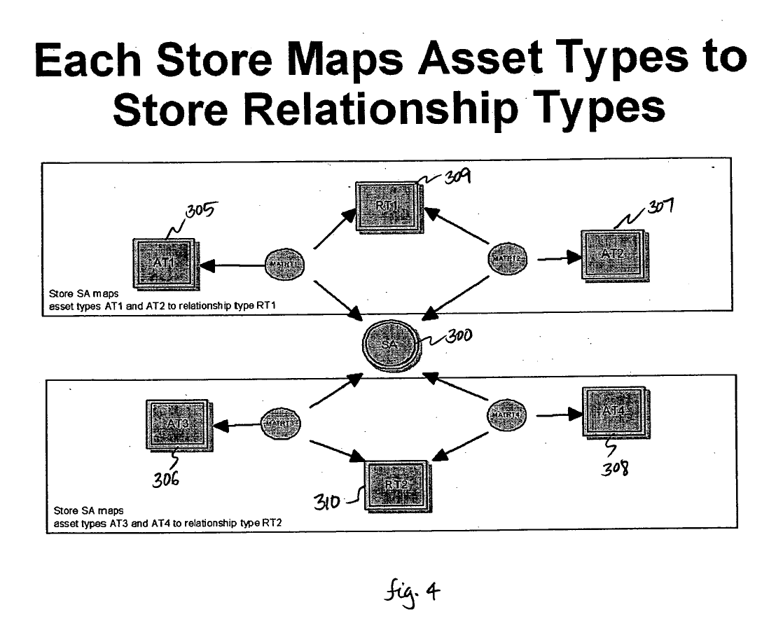

Referring to FIG. 3, there is shown an exemplary structure for a store (SA) 300 pursuant to an embodiment of the present invention. The store 300 has commerce assets (CA1) 301, (CA2) 302, and (CA3) 303, (CA4) 304 of types (AT1) 305, (AT2) 306 respectively. The commerce assets 301, 302, and 303, 304 are information relating to various goods or services offered by the store 300, and can be, for example, computer products, household items, electronics, food products, health care service, web services such as e-greetings, web radio, digital music, etc. Alternatively, the commerce assets 301, 302, and 303, 304 may also include information on various wares or services which are available at another store yet may be purchased through the intermediary of the store 300, or physical or digital services indirectly obtainable from the store 300. The types 305, 306 broadly define the categories of the commerce assets 301, 302, and 303, 304, respectively, available at store 300. As illustrated in FIG. 4, each type 305, 307 and 306, 308 is further mapped into a relationship type (RT1) 309 and (RT2) 310, respectively.

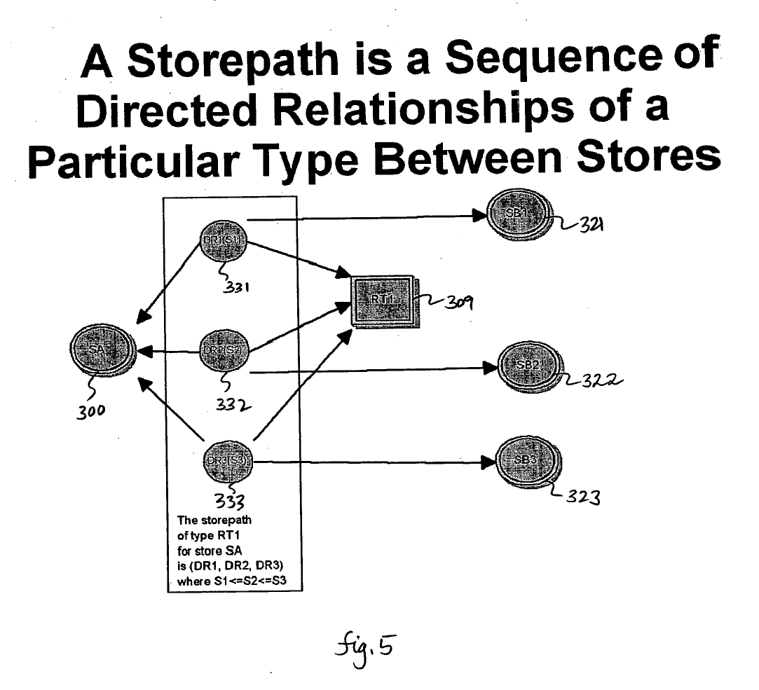

Referring now to FIG. 5, the construct of a storepath is defined. In a broad aspect, a storepath serves as an identifier for commerce assets of a store, and can be defined for each relationship type. The storepaths can support various types of commerce assets, such as, but not limited to, wares or services catalogs, marketing information, business relationships, inventory item definitions, inventory tracking, prices, calculation methods, currency exchange information, measurement information, and language and locale related information.

The storepath for the store 300 is shown as the sequence of typed directed relationships (DR1) 331, (DR2) 332 and (DR3) 333 between the store 300 and a set of related stores (SB1) 321, (SB2) 322, (SB3) 323, in which the directed relationships 331, 332, 333 are all of the same type 309, and have sequencing attribute values S1, S2 and S2 respectively, such that S1 is less than or equal to S2, which is less than or equal to S3. Generally, for the element:

(SA, SB, RT, S) Eq. 1

where: SA represents the store (SA) 300; SB represents one of the related stores (SB1) 321, (SB2) 322, or (SB3) 323; RT represents the relationship types such as types (RT1) 309, (RT2) 310, (RT3) 311; and S is a number which may be used to sequence relationships with the same type; then a storepath SP may be represented as the ordered set:

{(SA, SB1, RT1, S1),(SA, SB2, RT2, S2), . . . ,(SA, SBn, RTn, Sn)} Eq. 2

where: S1≦S2≦ . . . ≦Sn; and n is an integer representing the number of relationships in the storepath.

The set of storepaths for all stores can be therefore defined by a mapping function MSP, which maps store and relationship types to an ordered list of related stores:

MSP(SA, RT) [symbol] (SB1, SB2, SBn) Eq. 3

Generally, since each commerce asset CA has a relating commerce asset type AT and an associated store AS, the set of commerce assets of type AT for store AS can be represented as:

{(CA1, AT, AS),(CA2, AT, AS), . . . ,(CAn,AT,AS)} Eq. 4

Moreover, the set of asset types for a storepath SP can be represented as:

{(AT1, RT, SA),(AT2, RT, SA), . . . ,(ATn, RT, SA)} Eq. 5

It is therefore possible to represent a mapping MATRT relating the asset type AT and the relationship type RT for each store SA 300 as:

MATRT(SA, AT) [symbol] RT Eq. 6

The mappings MSP and MATRT may be cached into a computer memory for ease and rapidity of access.

Accordingly, a commerce asset CA is available to a store (SA) 300 by way of a storepath SP so long as it is associated with a storepath SP and its asset type AT is mapped by store (SA) 300 to a relationship type RT of storepath SP. An ordered list of the commerce assets CA with asset type AT available to the store (SA) 300 by way of storepath SP can therefore be represented by the ordered set:

{(CA1, SA, SBk1, AT, RT, S1),(CA2, SA, SBk2, AT, RT, S2), . . . ,(CAn, SA, SBkn, AT, RT, Sn)} Eq. 7

or, simply:

{(CA1, SBk1, Sk1),(CA2, SBk2, Sk2), . . . ,(CAn, SBkn, Skm)} Eq. 8

where: Sk1≦Sk2≦ . . . ≦Skm; and m is an integer representing the number of relationships in the storepath for relationship type RT.

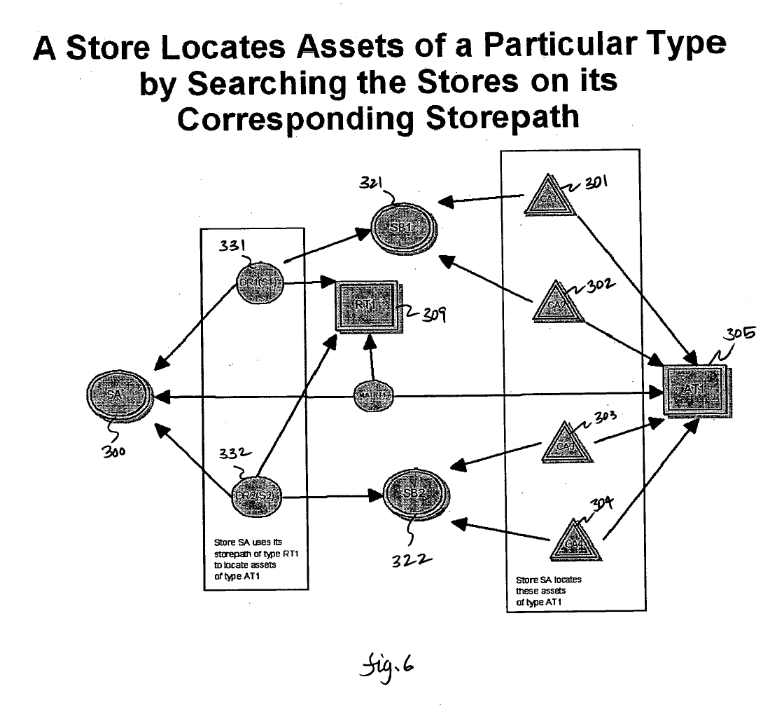

Referring now to FIG. 6, there is shown a diagrammatic representation of the relationship between a store 300 and a particular asset type AT1 305. As shown in FIG. 6, the commerce assets 301, 302, 303, 304 are all of type 305. Commerce assets 301 and 302 can be found in store 321, and commerce assets 303 and 304 can be found in store 322. The sequence attribute values S1 and S2 of typed directed relations DR1(S1) 331 and DR2(S2) 332 are sequence attributes determine the relative position of stores (SB1) 321 and (SB2) 322 in the storepath, or otherwise said, the sequence according to which the stores 321 and 322 are to be accessed. The asset type 305 is further mapped to RT1 309 for store (SA) 300. Based on the foregoing, a storepath mapping MSP can be composed with the asset type AT to relationship type RT mapping MATRT as follows:

MSP(SA, MATRT(SA, AT)) Eq. 9

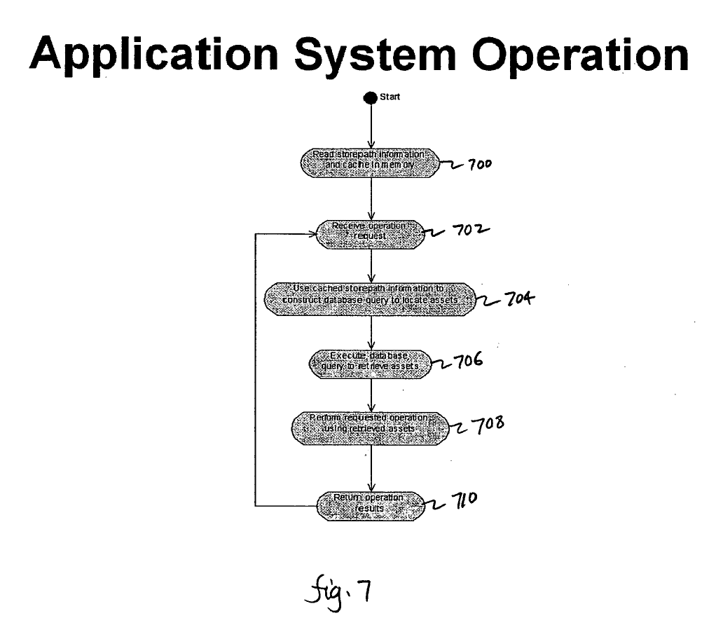

Referring now to FIG. 7, there is shown a flow diagram indicating the steps performed by the business logic 205 (shown in FIG. 2) of the application server 204 (shown in FIG. 2) to locate assets of a particular type 301, 302, 303, 304 (shown in FIG. 6) for the store 300. As a preliminary step, the storepath information is loaded into cache memory (Step 700) for fast access. A store operation query for locating certain assets for a store, typically embedded in a URL format for a particular store is entered by a consumer at a client 202 using the interface 203 (shown in FIG. 2) and passed to the HTTP server 207 en route to the application server 204. The business logic 205 of application server 204 receives the URL (Step 702) and resolves it into one or more database query statements using the using the cached storepath information (Step 704). In an embodiment of the invention based on the Structured Query Language (SQL), a single SQL statement similar to the following may be constructed and executed:

SELECT 1, CA, SB from T where SB=B1 UNION 2, CA, SB where SB=B2 . . . UNION n, CA, SB where SB=Bn ORDER BY 1 Eq. 10

or alternatively, several SQL statements similar to the following may be constructed and executed in sequence:

SELECT CA, SB from T where SB=Bi Eq. 11

where: T represents the relational table containing the commerce assets, CA represents the commerce assets retrieved, SB represents the stores from which they are retrieved, an Bi (for i=1 to n where n is an integer) are the stores to be searched, obtained from the caches composite mapping MSP(SA, MATRT(SA, AT)) for a particular store SA and asset type AT.

The database query statement is then passed on to the database management system 311 (shown in FIG. 2) of resource manager 210 (shown in FIG. 2), which executes the SQL statement to retrieve the requested assets from database 206 (shown in FIG. 2) (Step 706), performs required database operation using the retrieved assets (Step 708), and eventually generates a response and reports to the consumer's store operation query (Step 600).

As it can be appreciated, only a store 300 and an asset type 305, 306, 307, or 308 is required to retrieve all available commerce assets in the storepath relating to that asset type.

The use of a single storepath allows potential consumers to search for products or services of interest and comparison shop the same or different products or services among the resellers. Product searching and comparison shopping in a single catalog also exposes smaller sellers to buyers that are normally not aware of these smaller sellers but for their inclusion in the catalog. Furthermore, using a generic store profile allows small businesses, which do not have the infrastructure to host catalogs, to engage in e-commerce.

It will be appreciated, by those skilled in the art, that the article can be a signal bearing medium having means for transporting computer readable code to a client/server system over a network, in which the code can be used to implement the method.

It will also be appreciated, by those skilled in the art, that the computer program product includes a computer readable medium having computer executable code for directing a client/server system to implement the method. The computer program product can also be called a computer-readable memory, in which the memory can be a CD, floppy disk or hard drive or any sort of memory device usable by a client/server system. It will also be appreciated, by those skilled in the art, that a client/server system may be configured to operate the method (either by use of computer executable code residing in a medium or by use of dedicated hardware modules, also generally or generically known as mechanisms or means, which may operate in an equivalent manner to the code which is well known in the art).

The present invention may be embodied in other specific forms without departing from the spirit or essential characteristics thereof. Certain adaptations and modifications of the invention will be obvious to those skilled in the art. Therefore, the presently discussed embodiments are considered to be illustrative and not restrictive, the scope of the invention being indicated by the appended claims rather than the foregoing description, and all changes which come within the meaning and range of equivalency of the claims are therefore intended to be embraced therein.

Furthermore, the foregoing detailed description of the embodiments of the present invention does not limit the implementation of the invention to any particular computer programming language. The present invention may be implemented in any computer programming language provided that the OS (Operating System) provides the facilities that may support the requirements of the present invention. Embodiments of the present invention may be implemented in the C or C++, COBOL, FORTRAN, Java™ or REXX computer programming language (or other computer programming languages in conjunction with C/C++). Any limitations presented would be a result of a particular type of operating system, computer programming language, data processing system, or database management system, and would not be a limitation of the present invention.

What is claimed is:

1. A method of accessing data regarding commerce assets such as products or services offered at virtual stores participating in a virtual marketplace in a client/server system based on a user query for data relating to a commerce asset for a particular asset type at a particular virtual store, the user accessing the client/server system through a client having a graphical user interface to obtain the user query and to display a response to the query, the assets data being stored in a database accessed by a resource manager, an application server interfacing the resource manager with graphical user interface, said method comprising the steps of:
a) establishing a storepath relationship correlating asset types among related stores;
b) resolving the user query into at least a database query executable by the resource manager;
c) retrieving assets data for asset type available at particular virtual store; and
d) returning assets data to user as the response to the query.

2. The method as set forth in claim 1, further comprising the step of:
e) storing storepaths relationships in memory.

3. The method as set forth in claim 2, wherein the step of resolving the user query into at least a database query executable by the resource manager further comprises constructing the database queries based on the storepaths relationships in the memory.

4. The method as set forth in claim 1, wherein the each store SA has commerce assets CA having asset types AT.

5. The method as set forth in claim 4, wherein each of the asset types AT is mapped into relationship type RT for each store SA.

6. The method as set forth in claim 5, wherein the storepath for store SA and related stores SBn for relationship types RTn is determined based on an ordered list:
{(SA, SB1, RT1, S1),(SA, SB2, RT2, S2), . . . ,(SA, SBn, RTn, Sn)}
where S is a value which may be used to sequence relationships with the same type, and S1≦S2≦ . . . ≦Sn; and n is an integer representing the number of relationships in the storepath.

7. The method as set forth in claim 6, wherein the storepath relationships for the stores are defined by a mapping function MSP( ) as:
MSP(SA, RT) [symbol] (SB1, SB2, . . . , SBn)
and the mapping function MSP( ) mapping the store SA and the relationship type RT to an ordered list of related stores.

8. The method as set forth in claim 7, wherein the set of asset types AT for the storepath is represented by an ordered list:
{(AT1, RT, SA),(AT2, RT, SA), . . . ,(ATn, RT, SA)}.

9. The method as set forth in claim 8, wherein a mapping function MATRT( ) between the asset type AT and the relationship type RT is defined as:
MATRT(SA, AT) [symbol] RT.

10. The method as set forth in claim 9, wherein the list of commerce assets CA having the asset type AT for the store SA are defined by an ordered list:
{(CA1, SBk1, Sk1),(CA2, SBk2, Sk2), . . . ,(CAn, SBkn, Skm)}
where Sk1≦Sk2≦ . . . ≦Skm; and m is an integer representing the number of relationships in the storepath with the same asset type AT.

11. The method as set forth in claim 10, wherein the storepath relationship for the store SA and an asset type AT is defined by a composite mapping function MSP( ) as follows:
MSP(SA, MATRT(SA, AT)).

12. A client/server system comprising:
at least one client having a graphical user interface for receiving a user's query for data relating to a commerce asset offered at a virtual store stored on a database;
an application server operatively connected to the client graphical user interface, the application server having a business logic component for resolving the query into at least a database query; and
a resource manager operatively connected to the application server, the resource manager including a database management system for processing the database queries, accessing the database containing a response to the query, retrieving and forwarding the response to the application server.

13. The client/server system as set forth in claim 12, wherein the virtual store is a participant in a virtual marketing campaign including a plurality of participant virtual stores.

14. The client/server system as set forth in claim 13, wherein the virtual stores are related to one another based on a storepath relationship correlating commerce asset types among the virtual stores.

15. The client/server system as set forth in claim 14, wherein the storepath relationship for a virtual store SA and an asset type AT is defined by a composite mapping function MSP( ) as follows:
MSP(SA, MATRT(SA, AT)).

16. A computer program product having a computer readable medium tangibly embodying computer executable code for directing a data processing system to access data regarding assets such as products or services offered at virtual stores participating in a marketplace in a client/server system based on a user query about data asset for a particular asset type at a particular virtual store, the user accessing the client/server system through a client having a graphical user interface to obtain the user query and to display a response to the query, the assets data being stored in a database accessed by a resource manager, an application server interfacing the resource manager with graphical user interface, said computer program product comprising:
code for establishing a storepath relationship correlating asset types among related stores;
code for resolving the user query into at least a database query executable by the resource manager;
code for retrieving assets data for the asset type available at a particular virtual store; and
code for returning assets data to user as the response to the user query.

17. The computer program as set forth in claim 16, further comprising code for storing the storepath relationships in memory.

18. The computer program as set forth in claim 17, further comprising code for constructing the database queries based on the storepath relationships stored in the memory.

19. A computer data signal embodied in a carrier wave and having means in the computer data signal for directing a data processing system to access data regarding assets such as products or services offered at virtual stores participating in a virtual marketplace in a client/server system based on a user query about data asset for a particular asset type at a particular virtual store, the user accessing the client/server system through a client having a graphical user interface to obtain the user query and to display a response to the query, the assets data being stored in a database accessed by a resource manager, an application server interfacing the resource manager with graphical user interface, the computer data signal comprising:
means in the computer data signal for establishing a storepath relationship correlating asset types among related stores;
means in the computer data signal for resolving the user query into at least a database query executable by the resource manager;
means in the computer data signal for retrieving assets data for the asset type available at a particular virtual store; and
means in the computer data signal for returning the assets data to user as the response to the user query.

20. The computer data signal as claimed in claim 19, further comprising means in the computer data signal for storing the storepath relationships in memory.

21. The computer data signal as claimed in claim 20, wherein the means in the computer data signal for resolving the user query into at least a database query executable by the resource manager further comprises means in the computer data signal for constructing the database queries based on the storepath relationships in the memory.
